(19) United States
(12) Patent Application Publication
(10) Pub. No.: US 2020/0157462 A1
(43) Pub. Date: May 21, 2020

(54) Olfactory bio fragrance dellivery system

(71) Applicant: Richard R. Tisdale, South Euclid, OH (US)

(72) Inventor: Richard R. Tisdale, South Euclid, OH (US)

(21) Appl. No.: 15/998,026

(22) Filed: Nov. 19, 2018

(51) Int. Cl. C11B 9/00

(52) U.S. Cl. CPC C11B 9/0061; C11B 9/008; C11B 9/0019; C11B 9/0034; C11B 9/0015

(57) ABSTRACT

The invention relates to human beings and their hundreds of active olfactory receptor genes which are devoted to detecting thousands of different fragrance molecules in the atmosphere. The influence of fragrances on the psycho physiological activities of human beings have been known for a long time in the cosmetic industries. These human senses play an important role in the physiological effects of fragrance delivery systems. Aromatic electrophysiological studies have revealed that aromatic fragrance delivery affect brain activities and cognitive functions which can be measured by an electroencephalograph (EEG). The patent submitted formula below infused with the claimed delivery system submitted below have been found to produce low levels of EEG temporal measures of responses in the central nervous system suggesting a significant role of a aromatic olfactory stimulation in the alteration of cognitive, mood and social behavior in retrospect the delivery system increased by 100 percent the alluring properties of the ingredients in the claim.

### TECHNICAL FIELD COSMETICS

The present invention relates to the enhancement of the normal use of alcohol to deliver fragrances to the senses. The present invention submitted in this application use the Trademark chemical compound of Exxon mobile in small trace amounts infused with pheromones to enhance the delivery of fragrances to the senses obtaining a better physiological effect.

### SUMMARY OF THE INVENTION

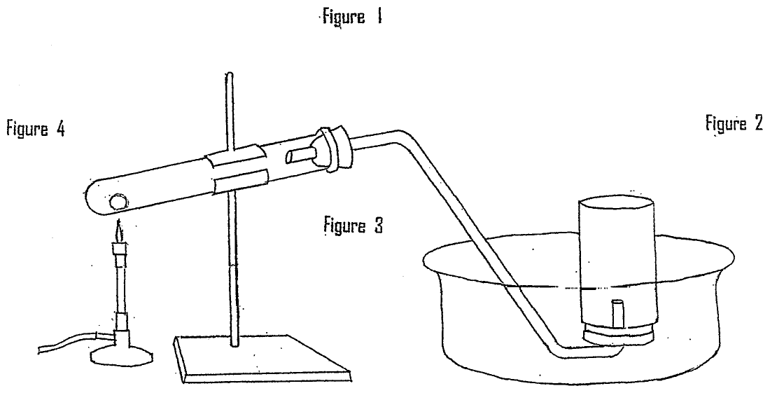

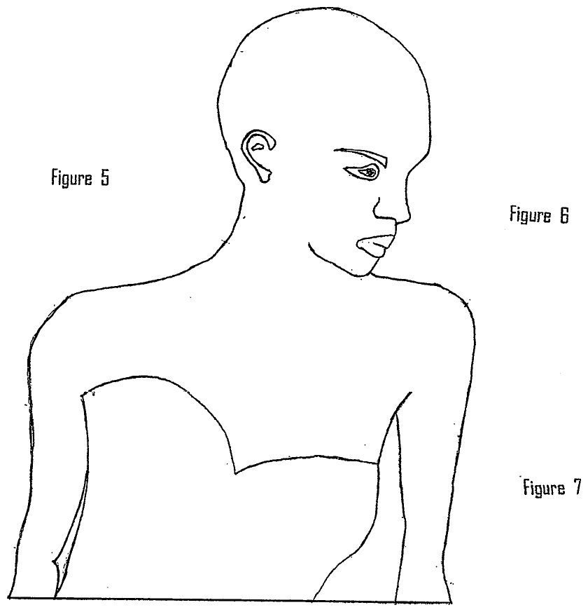

It is the object of the invention to use Isoparaffinic Hydrocarbon infused with a pheromone to enhance the olfactory delivery to the human senses. The Specification will breakdown in a two paragraph explanation of the physiological effect of the Patent's ingredients. The cosmetic industry have been using plain alcohol in there delivery systems for fragrances. Using Isoparffinic Hydrocarbon was found in the laboratory experiment to enhance the properties found in fragrance ingredients. Isoparaffinic Hydrocarbon Delivery System Ingredients these ingredients make up perfume, lotion and body oil place these three components in a test tube then mix the ingredients using a centrifuge or blender after the components are completely saturated, add the small trace amount of pheromone infused isoparaffinic hydrocarbon plus any fragrance. To release the fragrance for the effects two methods can be employed one the laboratory test a complete breakdown of the laboratory test is in the Drawing Part I FIG. 4 using a test tube heated to 98.6 degrees place a small trace amount of the solution in the tube allow the vapor to travel through the vapor tube into the cooling dish FIG. 2 of the Part I Drawing, mimicking room temperature the cognitive aromatic fragrance molecules will be released in the air. Part I Drawing where the Bunsen burner FIG. 3 is used to dissolve the serum and any human subject within three feet will feel a mild euphoric feeling come over them. This test can be done physically or with machines one simply involve the question “how does it make you feel?” the other involve attaching the subject to a electroencephalograph and reading the charted effects on brainwave and nervous patterns. (For a detailed explanation refer to the Patent Abstract located on page 3) When the ingredients located at the bottom paragraph of Patent's claim located on page 4 are mixed they simply make up a body lotion infused with the pheromone infused isoparaffinic hydrocarbon fragrance. Physically this solution can be applied to the body in three specific areas these areas are explained in more detail in the Drawing Part II with FIG. 5 showing how using small trace amounts only in the neck area, FIG. 6 show using the serum in the shoulder area and FIG. 7 of Drawing Part II show using a small trace amount in the arm area. When applied in this manner it replicates the laboratory test using the body's own 98.6 heat to release and deploy the olfactory delivery system producing a new inexpensive and efficient aromatic fragrance delivery system.

1. It is the object of the invention to use a light infusion of the compound Isoparaffinic Hydrocarbon (TM ExxonMobil Chemical Company) in the delivery system of the following ingredients 200 ml of 2 percent dimethicone, water, isopropyl palmitate, Avena sativa flour, cetyl alcohol, glycerin, distearyldimonium chloride, benzyl alcohol, sodium chloride 10 ml alcohol fragrance, water butylphenyl methypropional, benzyl benzoate, benzyl cinnamate, cinnamyl alcohol, citral citronellol coumarin, eugenol, Evernia furfuracea extract, geraniol, hexyl cinnamal, hydroxycitronellal, isoeugenol, limonene, linalool, butyl methoxydibenzoylmethane, ethylhexyl methoxycinnamate, ethylhexyl salicylate, violet extract, red 4, yellow 5, 2 ml of fragrance, 100 ml of purified water, 41 ml of paraffinum liquidum, isopropyl palmitate, aloe barbadensis leaf extract, tocopheryl acetate parfum, 2 ml phenolic aldehyde (Vanillin), 2 ml of fragrance, 2.1 ml of a 2 percent pheromone infused isoparaffinic hydrocarbon fragrance. The object of the present invention is to provide the Isoparaffinic Hydrocarbon delivery system, this system will deliver the ingredients formed in the pheromone infused fragrances, using the humans body's own natural heat to produce a inexpensive and efficient aromatic delivery system for the fragrance.
